(19) United States
(12) Patent Application Publication
(10) Pub. No.: US 2026/0302739 A1
(43) Pub. Date: Oct. 1, 2026

(54) Cable Clamping Device with Two Independently Operable Clamping Arms

(71) Applicant: TELEFONAKTIEBOLAGET LM ERICSSON (PUBL), Stockholm (SE)

(72) Inventor: Magnus Petersson, Uppsala (SE)

(21) Appl. No.: 19/477,985

(22) PCT Filed: May 17, 2023
(86) PCT No.: PCT/SE2023/050489

§ 371 Date: Oct. 23, 2025

(51) Int. Cl. H02G 3/02

(52) U.S. Cl. CPC H02G 3/02

(57) ABSTRACT

There is provided a cable clamping device (100) for a telecommunication network node, including a base (110) with attachment points (140) for securing the base to the node, and first and second arms (120a, 120b) pivotably connected to the base around a respective pivot axis (130a, 130b). The base and each of the first arm and the second arm are configured to clamp one or more cables received between the arm and the base by pivoting the arm in a first direction to a closed position, and to released such clamped cables by instead pivoting the arm in an opposite, second direction to an open position. Each of the first and second arms is operable between its respective open and closed positions independently of the other arm, such that cables can be clamped/released by/from one arm without affecting cables clamped by the other arm.

### TECHNICAL FIELD

The present disclosure relates to the field of cable clamping devices. In particular, the present disclosure relates to a cable clamping device suitable for use in telecommunication network nodes or similar.

### BACKGROUND

A telecommunication network node is often (inter-)connected using a plurality of cables, such as e.g. one or more power cables, signal cables, and similar. In order to avoid damaging the node, it is often imperative that the cables are installed in the node in such a way that any stress or strain present in the cables is prevented from being transferred to the connections and circuitry of the node. In addition, it is often also desirable that the installation of cables is well organized, as a neat installation may help to more easily track down a fault in one or more of the cables or connections, avoid unnecessary restriction of airflow within the node, and/or e.g. help to reduce an entrapment of dust or other unwanted particles therein.

Due to the above requirements, the installation space within the node is often provided with one or more cable clamping devices (i.e. “clamps”), in which the cables can be tightly secured and arranged, and by which suitable strain-/stress-relief may be obtained. To reduce the required number of clamps, each clamp is often configured to accommodate more than one cable, and often also configured to simultaneously secure and release all cables at once by closing or opening of the clamp, respectively.

As the number of cables grows large, such multi-cable clamps may however make the installation process more cumbersome, in particular if the cables are to be installed in a non-horizontal orientation such that gravity may pull the cables out of the clamp before all cables have been received and the clamp has been closed. In addition, adding or removing cables at a later stage (such as during e.g. maintenance or upgrading of the node) may also be difficult, as opening of the clamp may cause more than the desired cables to be released from the clamp.

### SUMMARY

In order to at least partially overcome the above-mentioned issues with conventional cable clamping devices, the present disclosure provides an improved cable clamping device for a telecommunication network node as defined in and by the accompanying independent claim. Various embodiments of the cable clamping device are also provided and defined in and by the accompanying dependent claims.

According to an aspect of the present disclosure, there is provided a cable clamping device for a telecommunication network node. Hereinafter, the terms “cable clamping device” and just “device” will be used interchangeably, if not stated to the contrary. The same applies also to the terms “telecommunication network node” and just “node”, which will be used interchangeably as well. The device includes a base which includes one or more attachment points for securing the base to an object (such as e.g. the node). The device further includes a first arm and a second arm, which are both pivotably connected to the base around a respective pivot axis. The base and each of the first arm and the second arm are further configured such that one or more cables inserted between the arm and the base can be clamped between a clamping section of the arm and a corresponding clamping section of the base by pivoting the arm in a first direction to a closed position, and such that any such clamped one or more cables can be released by instead pivoting the arm in an opposite, second direction to an open position. Each of the first and second arms is operable between its respective open and closed positions independently of the other arm, such that any one or more cables clamped between the corresponding clamping sections of the arm and the base can be released without also releasing any one or more cables clamped between the corresponding clamping sections of the other arm and the base.

Phrased differently, in the envisaged device, the first arm has a clamping section, and the base has a corresponding first clamping section, that are both arranged such that when the first arm is pivoted to its closed position (i.e., towards the base and the corresponding first clamping section of the base), the clamping section of the first arm and the corresponding first clamping section of the base are brought towards each other such that one or more cables can be clamped therebetween. Similarly, the second arm has its own clamping section, and the base has a corresponding second clamping section, that are both arranged such that when the second arm is pivoted to its closed position (i.e., towards the base and the corresponding second clamping section of the base), the clamping section of the second arm and the corresponding second clamping section of the base are brought towards each other such that one or more other cables can be clamped therebetween. Correspondingly, when the first arm is pivoted to its open position (i.e., away from the base and from the corresponding first clamping section of the base), the clamping section of the first arm and the corresponding first clamping section of the base are brought away from each other, such that any one or more cables currently clamped therebetween can be released from the device. Likewise, when the second arm is pivoted to its open position (i.e., away from the base and from the corresponding second clamping section of the base), the clamping section of the second arm and the corresponding second clamping section of the base are brought away from each other, such that any one or more other cables currently clamped therebetween can be released from the device. In particular, the first and second arms, the base and all of the clamping sections are configured such that the arms may be operated independently, and such that the opening/closing of one arm does not affect the other arm and the cables clamped between the base and this other arm. Herein, when referring to the first arm and the “corresponding” clamping section of the base, the corresponding clamping section of the base is thus the first clamping section of the base. Similarly, when referring to the second arm and the “corresponding” clamping section of the base, the corresponding clamping section of the base is thus the second clamping section of the base.

As used herein, a “telecommunication network node” (or “node”) may e.g. be a radio base station, (open) radio access network (RAN or ORAN) node, base transceiver station, Node B, evolved Node B, gNB, access point, integrated access and/or backhaul node, antenna module, or other components found and used in telecommunication networks used to connect terminal devices and user equipment (such as cellphones) together, and in which there is a need to clamp cables as part of an installation thereof.

The envisaged device improves upon currently available clamping devices in that it contains two arms that can be operated independently, such that cables currently being clamped between one arm and the base may be e.g. removed/unclamped without also simultaneously unclamping cables currently being clamped between the other arm and the base. This provides a more flexible installation and reduces the problems discussed earlier herein, where e.g. removal of one or more cables would risk a falling-out of one or more other cables in a non-desired way. With the envisaged, improved device, cables which are more likely to be removed/installed simultaneously can be placed between the same arm and the base, while other cables can be installed/clamped between the other arm and the base. Also, cables can first be installed between only one of the arms and the base, leaving additional room for one or more future cables to be installed between the other arms and the base, and then without having to affect the already installed cables due to the independency of the two arms.

In some embodiments of the device, the pivot axes of the first and second arms may be a same pivot axis, such as e.g. a same hinge or other structure capable of providing the pivotable connection of each of the arms to the base. Having only a single, shared pivot axis may e.g. help to reduce the complexity of the device, reduce the cost of manufacturing and e.g. also reduce the overall size of the device. In other embodiments, the pivot axes of the first and second arms may instead be different pivot axis, such as e.g. two different hinges or other structures capable of providing the pivotable connection of each of the arms to the base.

In some embodiments of the device, for at least the first and second arms, at least one of the clamping section of the arm and the corresponding clamping section of the base may have a metallic surface electrically connected to the one or more attachment points of the base. In some embodiments of the device, the metallic surface may instead, or in addition, be electrically connected to a metallic surface of the base which is arranged to, with the device mounted to the node, come into contact with the node. By providing the metallic surface at the clamping section(s), a grounding/earthing connection can be formed between the cable (if suitably stripped at the clamping section(s)) and the base, node and the ground/earth (assuming that the node is itself grounded/earthed). The envisaged device may thus provide both clamping, strain-/stress-relief and grounding/earthing for the cables.

In some embodiments of the device, for at least one of the first and second arms, the corresponding clamping section of the base may include one or more grooves for receiving the one or more cables and oriented along the pivot axis of the arm. The one or more grooves may e.g. be dimensioned in order to match a dimension(s) of the cables which are to be clamped between the arm and base, such that, when pressed against the base by the arm, the cable is pressed against the base and held firmly in the groove. A groove as envisaged herein may e.g. have a smooth surface, or e.g. a patterned surface configured to increase friction between the surface and the cable, to further improve the holding power of the device with respect to the cable (when clamped). In particular, providing the one or more grooves may allow for e.g. a cable to remain within a groove even when the arm is brought to its open position, such that the cable does not fall out of the device due to gravity, but such that the cable has to be manually removed from the device by e.g. a hand or other tool of an installer/service technician or similar. This may help to prevent undesired falling-out of cables once the arm is opened, which may be helpful e.g. while some cables are yet to be installed before the arm is closed, or e.g. if the arm is opened in order to remove/replace only a few cables, or similar.

In some embodiments of the device, for the at least one of the first and second arms, the clamping section of the arm may include one or more protrusions for, with the arm in its closed position, pressing the one or more cables into the one or more grooves of the corresponding clamping section of the base. Providing the one or more protrusions may e.g. help to further increase the clamping force exceeded on the cable with the arm(s) in the closed position. Providing the one or more protrusions may e.g. also help to provide sufficient clamping force even if e.g. a dimension of a groove is larger than a dimension of the cable therein.

In some embodiments of the device, the corresponding clamping sections of the base for the first and second arms may be located on opposite sides of the base. Consequently, the arms may be located such that they are also, when in their respective closed positions, on opposite sides of the base. Cables may thus be installed/released on/from e.g. a left side of the device independently of cables installed/released on/from e.g. a right side of the device, and vice versa.

In some embodiments of the device, the base may have a bottom section including the one or more attachment points, a top section where the first and second arms are pivotably connected to the base, and a middle section extending longitudinally between the bottom and top sections. The corresponding clamping sections of the base for the first and second arms may be located on opposite lateral sides of the top section.

In some embodiments of the device, the corresponding clamping sections of the base for the first and second arms may be angled with respect to the longitudinal extension of the base and/or middle section, and may be closer together towards the respective pivot axes (or the single pivot axis, if both arms share a same pivot axis) for the first and second arms than towards the middle section of the base. Making the clamping sections of the base angled in this way may e.g. help to increase the clamping force compared to if e.g. having the clamping sections of the base aligned along completely along the longitudinal extension of the base and/or middle section.

In some embodiments of the device, a distance may be provided between the bottom section and the top section including the corresponding clamping sections of the base for the first and the second arms, to provide room therebetween in the middle section for one or more additional, not-to-be-clamped cables. For example, cables which are not likely to be replaced and/or repaired may thus be installed below the cables which are to be clamped, with the benefits that the to-be-clamped cables can be replaced and/or repaired without affecting the cables below.

In some embodiments of the device, the first and second arms may each include a first end and a second end, wherein the clamping section of the arm is provided between the first and second ends of the arm, and wherein the arm is pivotably connected to the base at the first end.

In some embodiments of the device, the first and second arms may each include a screw. The screw may be held captive in the arm, and the base may further include a corresponding (threaded) hole configured to receive the screw such that the arm is forced, or maintained in, its closed position by tightening of the screw. Such a screw may thus help to provide a simple installation procedure, as a regular screw driver may be the only tool required to open/close the arms and thereby release/clamp the cables. That the screw is “held captive” may e.g. be obtained by the screw being provided in a hole of the arm, wherein a configuration of the screw is such that its dimensions (when inserted into the hole) above and below the hole are larger than a dimension of the hole, such that the screw may not fall of the hole in the arm even when the screw is unscrewed from the (threaded) hole in the base. Other envisaged alternatives may e.g. include a string or similar provided to hold the screw attached to the arm, or similar. In any alternative, holding the screw captive in the arm may provide an easier installation, as the risk of losing the screw is reduced or eliminated.

In some embodiments of the device, for each of the first and second arms, the screw may be provided at the second end of the arm. Phrased differently, the hole in the arm through which the screw is inserted (and held captive) may be provided at the second end of the arm. Preferably, the holes in the base and in the arms are aligned in orientations such that, with the arm in its closed position, the orientation of the hole in the arm matches an orientation of the (threaded) hole in the base. In such embodiments, the cables are thus clamped between the pivot connection to the base and the screw. In other embodiments, the screw of (and the hole in) the arm may e.g. be provided somewhere else, e.g. at the middle of the arm, and the cables may then in some embodiments be clamped both between the screw and the pivot connection to the base, and between e.g. the screw and the other end of the arm. The exact location of the screw along the arm may be tailored depending on the desired clamping force, taking the length between the screw and the pivot connection to the base into account to calculate the resulting clamping force along different positions of the arm.

In some embodiments of the device, the corresponding threaded holes in the base for the first and second arms may be aligned parallelly with the longitudinal extension of the middle section.

In some embodiments of the device, the base and each of the first and second arms may be further configured such that at least two or more (e.g. two, three, four, . . . , ten, . . . , fifteen, . . . , or even more) cables inserted between the arm and the base can be clamped between the clamping section of the arm and the corresponding clamping section of the base. This may be achieved by e.g. making the arms longer, or similar. Having more cables clampable between each arm and the base may allow to e.g. use fewer clamps in total. In addition, the envisaged device may also be used such that at first, only one arm is used for clamping, which leaves plenty of room for later install of other cables between the other arm and the base, which cables may then be installed without affecting the cables already installed between the first arm and base, etc.

Other objects and advantages of the present disclosure will be apparent from the following detailed description, the drawings and the claims.

### BRIEF DESCRIPTION OF THE DRAWINGS

Exemplifying embodiments will be described below with reference to the accompanying drawings, in which:

FIGS. 1A and 1B schematically illustrate perspective views of a cable clamping device according to embodiments of the present disclosure, with the arms their closed and open positions, respectively;

FIGS. 1C and 1D schematically illustrate side views of the cable clamping devices shown in FIGS. 1A and 1B;

FIG. 1E schematically illustrates a perspective view of a cable clamping device according to embodiments of the present disclosure, with cables being clamped by the device;

FIG. 1F schematically illustrates a side view of a cable clamping device according to embodiments of the present disclosure, with cables being clamped by the device and other, not-to-be-clamped cables provided below the clamped cables;

FIG. 1G schematically illustrates a side view of a cable clamping device according to embodiments of the present disclosure, with the arms having separate pivot axes;

FIG. 1H schematically illustrates a side view of a cable clamping device according to embodiments of the present disclosure, with the arms being provided with one or more protrusions;

FIG. 1I schematically illustrates a side view of arms of a cable clamping device according to embodiments of the present disclosure,

FIG. 1J schematically illustrates a perspective view of a cable clamping device according to embodiments of the present disclosure, including an additional set of clamping structures, and

FIG. 1K schematically illustrates a side view of the cable clamping device shown in FIG. 1J.

In the drawings, like reference numerals will be used for like elements unless stated otherwise. Unless explicitly stated to the contrary, the drawings show only such elements that are necessary to illustrate the example embodiments, while other elements, in the interest of clarity, may be omitted or merely suggested.

### DETAILED DESCRIPTION

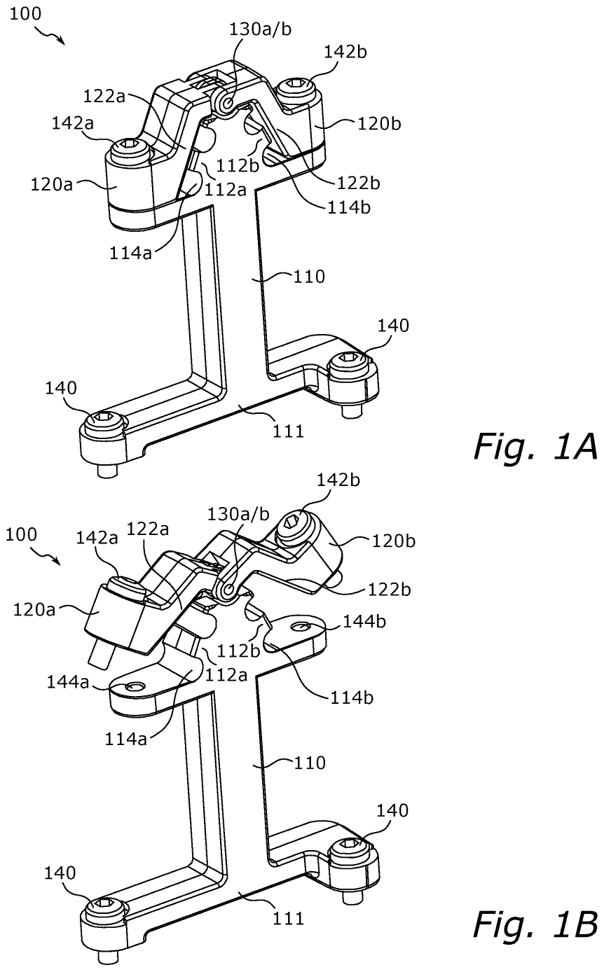

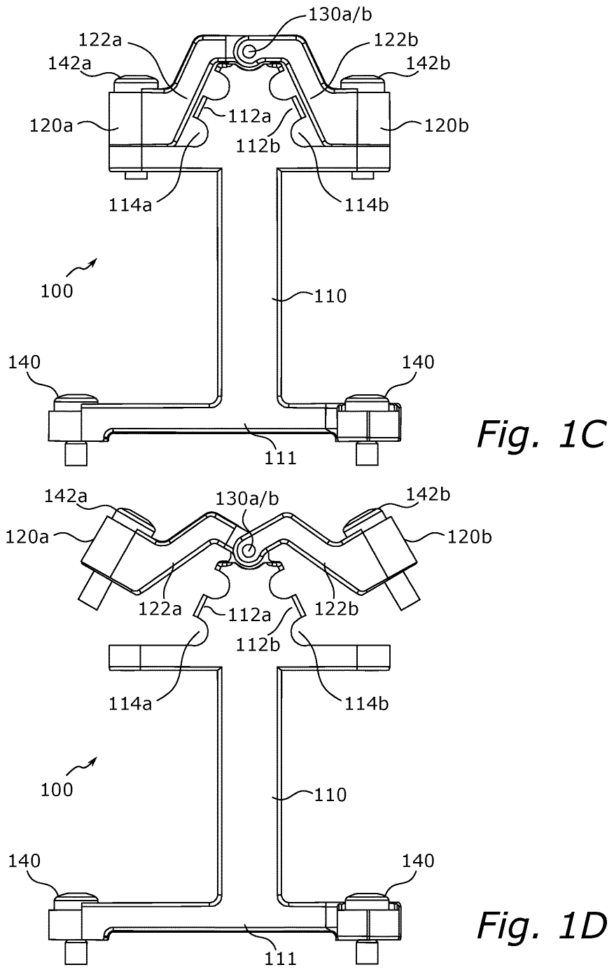

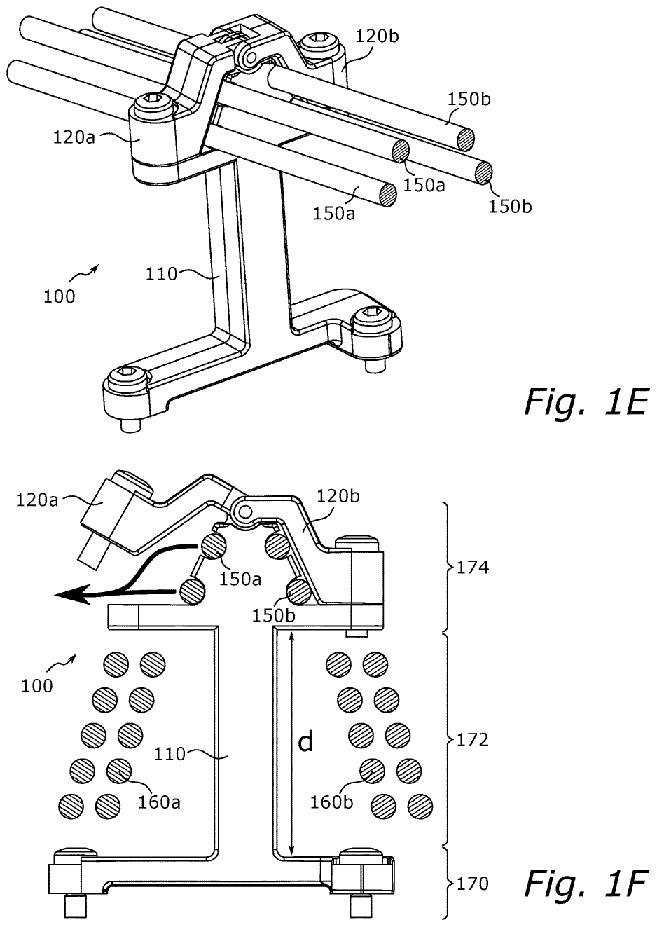

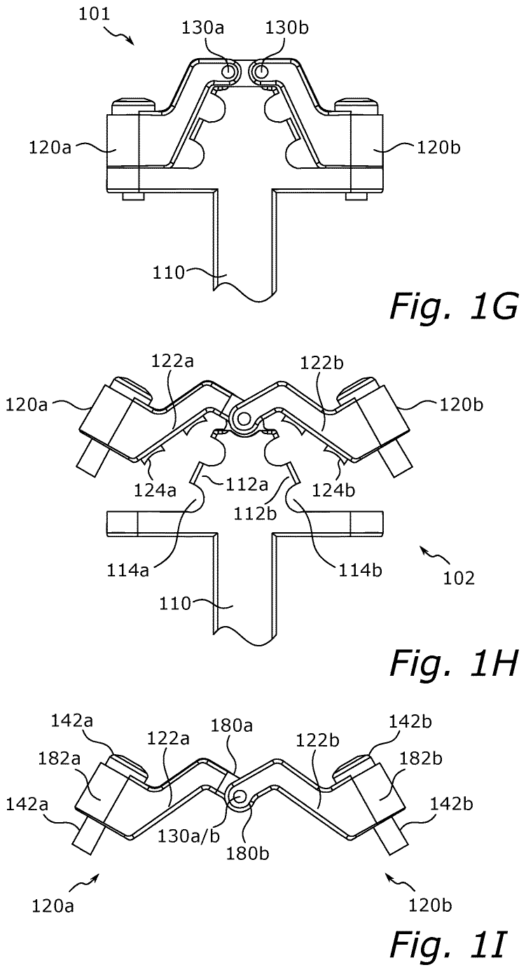

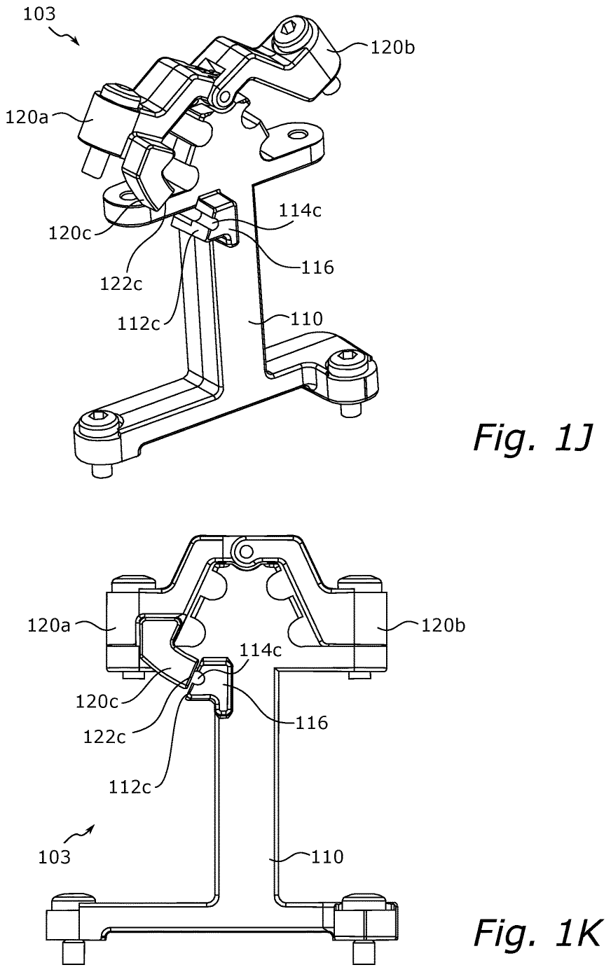

Examples of how the envisaged device of the present disclosure can be embodied will now be described in more detail with reference to FIGS. 1A-1J of the accompanying drawings. The drawings show only some, possible embodiments of the device, and the inventive device should thus not be construed as limited only to the embodiments set forth herein. To the contrary, the scope of the inventive device is limited by the accompanying claims, and the drawings and embodiments thereof described herein are provided for thoroughness and completeness only, and to fully convey the scope of the inventive device of the present disclosure to the skilled person.

Various embodiments of a device as envisaged herein will now be described with reference first to FIGS. 1A-1F.

FIGS. 1A and 1C show respective perspective and side views of an embodiment of a (cable clamping) device 100 as envisaged herein, suitable for use with a telecommunication equipment such as a telecommunication network node. The device 100 includes a base 110, which has a “foot” 111 that is provided with attachment points 140 for securing the foot 111 (and thereby also the base 110 and the device 100 itself) to a node. The shape of the foot 111 may be as shown in FIGS. 1A and 1C, but may of course also be shaped differently depending on e.g. the configuration of the node in which the device 100 is to be installed. For example, there may be more than the two attachment points 140 shown in FIGS. 1A and 1C, or only a single attachment point. The shape of the foot 111 may e.g. be L-shaped (as illustrated in FIGS. 1A and 1C), C-shaped, U-shaped, straight, or have any other suitable shape.

The device 100 further includes a first arm 120a and a second arm 120b, which are both pivotably connected to the base 110 around a same pivot axis provided by a hinge 130a/b. Each of the arms 120a and 120b is pivotable around the hinge 130a/b between respective open and closed positions. In FIGS. 1A and 1C, both arms 120a and 120b are shown in their closed positions.

In the particular example shown in FIGS. 1A and 1C, each arm 120a and 120b is provided with a respective screw 142a and 142b, which can be screwed into a corresponding threaded hole (not shown) in the base in order to force (or at least maintain) the arms 120a and 120b into (or in) their closed positions as shown in FIGS. 1A and 1C. In other embodiments, the screws 142a and 142b may be replaced by other fastening means, such as e.g. clips, pins, nuts, bolts, or similar. It may also be envisaged that there are no fastening means 142a and 142b, and that for example the pivotable connection provided by the hinge 130a/b provides sufficient friction for the arms 120a and 120b to stay in their closed position, or similar.

The first arm 120a has a clamping section 122a and the base 110 has a corresponding (first) clamping section 112a. Likewise, the second arm 120b has a clamping section 122b, and the base 110 has a corresponding (second) clamping section 112b. The clamping sections 112a/b and 122a/b are configured and arranged such that with the arms 120a and 120b in their closed positions, one or more cables can be clamped between the clamping section 122a/b of each arm 120a/b and the corresponding clamping section 112a/b of the base 110.

In the particular embodiments illustrated in FIGS. 1A and 1C, the clamping sections 112a and 112b of the base 110 are provided with respective grooves 114a and 114b, which may further help to secure the cables when clamped, and in particular provide the benefit that the cables may remain in the grooves 114a and 114b even when the arms 120a and 120b are opened, such that the cables do not fall out of the device 100 due to e.g. gravity alone. In other embodiments, the grooves 114a and 114b may not be included, and the corresponding surfaces of the clamping sections 112a and 112b may instead be flat, or similar.

As each arm 120a and 120b is pivotably connected to the base 110 via the hinge 130a/b, the arms 120a and 120b are operable between open and closed positions. When in their closed positions, such as illustrated in FIGS. 1A and 1C, each arm 120a and 120b may be operated to its open position by pivoting the arms 120a and 120b around the hinge 130a/b (i.e., around the same pivot axis). For example, the first 120a arm may be operated from its closed position to its open position by, as seen in FIGS. 1A and 1C, pivoting the first arm 120a in a clockwise direction around the hinge 130a/b. Likewise, the second arm 120b may be operated from its closed position to its open position by, as also seen in FIGS. 1A and 1C, pivoting the second arm 120b in a counter-clockwise direction around the hinge 130a/b. Of course, if the screws 142a and 142b are tightened, the screws 142a and 142b should first be unscrewed in order to allow for such pivoting motion for the arms 120a and 120b.

FIGS. 1B and 1D illustrate respective perspective and side views of the same device 100 as in FIGS. 1A and 1C, but with the arms 120a and 120b in their open positions. The threaded holes 144a and 144b of the base 110 for accepting the respective screws 142a and 142b are now visible. To move the arms 120a and 120b back to their closed positions, the arms can be pivoted around the hinge 130a/b in opposite directions to what was required to move them to their open positions. For the first arm 120a, this includes pivoting the first arm 120a in a counter-clockwise direction, and for the second arm 120b this includes pivoting the second arm 120b in a clockwise direction, around the hinge 130a/b (if seen as in any one of FIGS. 1A-1D).

Importantly, the hinge 130a/b is such that each arm 120a and 120b can be pivoted independently of the other arm, at least once the other arm is secured in its closed position by using e.g. screws 142a and 142b and/or other suitable means for holding the other arm in its closed position. As explained earlier herein, this provides the benefit that cables can be e.g. removed/unclamped from one side of the device without simultaneously removing/unclamping cables from the other side of the device.

As shown in the FIGS. 1A-D, the hinge 130a/b providing the pivot-connection between each arm 120a/b and the base 110 can be formed by e.g. respective holes in the arms 120a and 120b and the base 110, and a pin extending through these holes. The longitudinal axis of the pin would then correspond to the orientation of the pivot axis shared between both arms 120a and 120b. Other solutions providing the same independency of the arms 120a and 120b are of course also possible but not illustrated or discussed further herein.

In this and other embodiments, the device 100 may be such that there is a metallic surface on at least one of the clamping sections 112a and 112b of the base and the clamping sections 122a and 122b of the first and second arms 120a and 120b, respectively. This metallic surface may be electrically connected to the one or more attachment points 140, and or to e.g. a surface of the base (such as an underside of the foot 111, not shown) which will be in contact with the node once the device has been installed therein using the attachment points 140. For example, if the surface of one or both of the clamping sections 112a and 112b is metallic, this may be achieved by the rest of the base 110 also being manufactured out of an electrically conductive material, such as a metal, or similar, or e.g. by providing one or more wires or other conductive paths between the clamping section(s) 112a and/or 112b and the attachment points 140 (or the surface of the base that will be in contact with the node once installed), or similar. This may thus allow a stripped part of a cable (i.e., a part of the cable where an inner conductive wire is exposed) to contact the metallic surface of the clamping section(s) 112a and/or 112b, and thus form an electrical connection between the stripped part of the wire and the point of the device 110 which will be in contact with the node once installed. If the node is itself grounded/earthed, the device 110 may thus provide a grounding/earthing also of the cable/wire. If instead providing the metallic surface as part of one or more of the clamping sections 122a and 122b of the arms 120a and 120b, the electrical connection between e.g. the points 140 and the metallic surface may be provided by making e.g. the hinge 130a/b, the arms 120a and 120b and the base 110 out of metal, or provide e.g. one or more wires across sections which are not metallic. Preferably, metallic surfaces can be provided on both the clamping sections 112a and 112b of the base 110 and the clamping sections 122a and 122b of the arms 120a and 120b, respectively, to further improve such an electrical connection and ground/earthing path between the cable/wire and the node/ground/earth.

In the embodiment shown in FIGS. 1A-1D, the grooves 114a and 114b at the clamping sections 112a and 112b of the base 110 are oriented in a same direction as the pivot axis of the arms 120a and 120b. Other orientations are of course also possible, such as e.g. providing the grooves 114a and 114b slightly angled with respect to the pivot axis of the arms 120a and 120b, if desired. The exact orientation of the grooves 114a and 114b is preferably adapted to fit how the cables that are to be clamped into the device 110 are oriented and supposed to be run, in order to reduce a bending of the cables caused by clamping them into the device 100.

FIG. 1E shows a same perspective view of the device 100 as in FIG. 1A, but wherein cables 150a and 150b have been inserted and clamped between the first and second arms 120a and 120b and the base 110, respectively. As can be seen in FIG. 1E, the cables 150a can e.g. be removed/unclamped from the device 100 by opening the first arm 120a, while the cables 150b are still securely clamped in the device 100 by the second arm 120b. Likewise, the cables 150b can be removed/unclamped from the device 100 by opening the second arm 120b, while the cables 150a are still securely clamped in the device 100 by the first arm 120a. Of course, if wanting to remove/unclamp all of the cables 150a and 150b, this can be achieved by opening of both arms 120a and 120b. As described earlier herein, this independence of the arms 120a and 120b from each other provides a more flexible installation process, and reduces e.g. the risk of accidentally removing the cables 150b while attempting to remove the cables 150a, and vice versa.

FIG. 1F shows a same side view of the device 100 as in FIGS. 1C and 1D, but where the first arm 120a is now in its open position and the second arm 120b is in its closed position. With the first arm 120a in its open position, the cables 150a clamped in the device 110 can be removed from the device 100 as shown by the solid arrow(s), while the cables 150b can remain clamped in the device 100 between the second arm 120b and the base 110.

As illustrated in FIG. 1F, a device as envisaged herein may in some embodiments be said to have a bottom section 170, a top section 174, and a middle section 172 which longitudinally extends between the bottom section 170 and the top section 174. The bottom section 170 is where the attachment points 170 are included, while the top section 174 is where the first and second arms 120a and 120b are pivotably connected to the base 110. As also illustrated in FIGS. 1A-1F, in some embodiments, the device 100 may be such that the corresponding clamping sections 112a and 112b of the base 110 for the first and second arms 120a and 120b, respectively, may be located on opposite lateral sides of the top section 174. As used herein, being located on a lateral side of the top section 174 also includes the possibility that the clamping sections 112a and 112b are angled with respect to e.g. the longitudinal extension of the base 110 and/or the middle section 172. Allowing the clamping sections 112a and 112b of the base 110 to be angled in this way may e.g. have the advantage that the arms 120a and 120b can be secured in their closed and clamping positions by screws (such as the screws 142a and 142b) which may be tightened from above instead of from the sides, or similar, which may facilitate installation. Another advantage is that, in contrast to e.g. having the clamping sections 112a and 112b arranged in a plane perpendicular to the longitudinal extension of the base 110 and/or middle section 172 (i.e., horizontally), the overall footprint of the device 100 (in the horizontal direction) remains small while still allowing for a same number of cables to be clamped in the device 100. As used herein, “horizontal” refers to a direction or plane perpendicular to the longitudinal extension of the base 110 and/or middle section 172, while, consequently, “vertical” refers to a direction or plane parallel with the longitudinal extension of the base 110 and/or middle section 172. It is thus assumed herein that “horizontal” is not connected to the actual orientation of the device 100, but rather defines a direction coinciding with e.g. a plane on which the device 100 is to be mounted, and vice versa for “vertical”.

Illustrated in FIG. 1F is also an embodiment of the device 100 wherein the longitudinal extension of the middle section 172 is such that a distance d is formed/provided between the bottom section 170 and the top section 174. The distance d is sufficient to provide room for one or more other cables 160a and 160b which are not to be clamped by the device 100 to be run between the bottom and top sections 170 and 174, respectively. By providing the distance d, the envisaged device 100 may in such embodiments thus allow for a compact installation of many cables, and in particular where cables that are not to be clamped can be installed below cables which are to be clamped in the device 100. An installer/operator may thus be provided direct access to the cables which need to be clamped, without first having to remove the cables which are not to be clamped, or similar. Likewise, such a direct access may improve visibility and ease of work, as there is less interference between cables that are to be clamped and cables that are not to be clamped (at least by the device). This may make the installation process easier, as In other embodiments of the envisaged device, it is envisaged that the distance d may instead be minimized or even removed by e.g. joining the top section 174 and the bottom section 170 together directly, without any middle section 172. Such a device may e.g. be advantageous in case there is no need to run any cables (such as the cables 160a and 160b) below the cables 150a and 150b, as the overall dimensions of the device can be further reduced especially in the longitudinal/vertical direction of the device.

Other embodiments of the envisaged device will now be described in more detail with reference to FIGS. 1G, 1H and 1I.

FIG. 1G schematically illustrates a side-view of a device 101 which is similar to the device 100 already described herein with reference to FIGS. 1A-1F, but with the difference that the two arms 120a and 120b now has separate pivot axes 130a and 130b which are not a same pivot axis. Here, there is a separate hinge (e.g., a pin) provided for each arm 120a and 120b.

FIG. 1H schematically illustrates a side-view of a device 102 which is similar to the device 100 in that it also has a single pivot axis shared by both arms 120a and 120b. Here, however, the clamping sections 122a and 122b of the first and second arms 120a and 120b, respectively, are provided with protrusions. The clamping section 122a of the first arm 120a has a set of protrusions 124a, while the clamping section 122b of the second arm 120b has a set of protrusions 124b. The protrusions 124a and 124b are arranged and configured such that, with the corresponding arm 120a/b in its closed position, the protrusions 124a/b will apply pressure on the one or more cables located in the grooves 114a/b. The protrusions 124a/b can thus serve to increase the applied clamping force on the cables, and e.g. also help to apply such clamping force on cables whose outer dimensions is e.g. smaller than the dimensions of the grooves 114a/b. Although not shown in any of the drawings, other embodiments are of course also envisaged. For example, protrusions such as the protrusions 124a and 124b may also be provided if there are e.g. two pivot axes 130a and 130b such as illustrated in FIG. 1G. Protrusions may also be provided even if there are e.g. no grooves 114a and 114b provided in the clamping sections 112a and 112b of the base 110, e.g. if the clamping sections 112a and 112b are instead flat or similar. In yet other embodiments, instead of protrusions, one or more grooves may be provided also in the clamping section 122a/b of the respective arm 120a/b, and there may e.g. be grooves in the clamping sections of both the arm and the base, or similar. Having grooves also (or instead) in the clamping section of an arm may for example be useful if a device as envisaged herein is to be installed non-horizontally, e.g. upside down or at an angle, such that the cables may at some point be prevented by the grooves of the arm from falling out of the device due to gravity.

FIG. 1I schematically illustrates a side-view of a pair of (clamping) arms as envisaged herein. Here, the first arm 122a is said to include a first end 180a and a second end 182a, while the second arm 122b is said to include a first end 180b and a second end 182b. The clamping section 122a of the first arm 120a is provided between the first end 180a and the second end 182a, while the clamping section 122b of the second arm 120b is provided between the first end 180b and the second end 182b. The first and second arms 120a and 120b are each pivotably connected to the base (via the pivot axis 130a/b in form of e.g. a pin/hinge) at their respective first ends 180a and 180b.

In some embodiments of the device, and as discussed earlier herein, the first and second arms 120a and 120b can include a respective screw 142a and 142b which is held captive in the arm, and which is configured to be received by a matching (threaded) hole in the base (e.g. a hole 144a/b such as illustrated in FIG. 1B). When the arm 120a/b is moved sufficiently towards its closed position, the screw 142a/b can then be inserted into the hole of the base, and tightened in order to force the arm 120a/b further towards its closed position. Likewise, once the arm 120a/b is in its closed position, the arm 120a/b can be maintained in this position by the help of the screw 142a/b. In the embodiments illustrated in FIG. 1I, the screw is located at the second end 182a/b of the respective arm 120a/b. In other embodiments, the screw 142a/b may instead be provided e.g. somewhere in between the first and second ends 180a/b and 182a/b of the arm 120a/b, or similar, depending on the desired clamping force when the screw 142a/b is tightened, and on e.g. the overall and desired geometry of the arms 120a and 120b and the device. As can be seen in e.g. FIG. 1B, in some embodiments of a device as envisaged herein, the (threaded) holes of the base 110 are aligned parallelly with the longitudinal extension of the base 110 and/or middle section 172 (i.e., “vertically”), such that the screws 142a and 142b of the arms 120a and 120b will also be “vertically” aligned once tightened.

Yet another embodiment of a device as envisaged herein will now be described in more detail with reference (also) to FIGS. 1J and 1K.

FIG. 1J schematically illustrates a perspective view of a device 103 with the arms 120a and 120b in their open positions, while FIG. 1K schematically illustrates a side view of the same device 103 but with the arms 120a and 120b in their closed positions. In the device 103, there is provided an additional clamping structure 120c on the first arm 120a. The structure 120c has a clamping section 122c. On the base 110, there is provided a corresponding clamping structure 116, which has a clamping section 112c which includes a groove 114c running along a same direction as the pivot axis around which the arms 120a and 120b are pivotably connected to the base 110. The clamping structures 120c and 116 and their clamping sections 122c and 112c are arranged such that when the first arm 120a is in its open position (as shown in FIG. 1J), an additional cable (not shown) can be inserted between the structures 120c and 116, preferably within the groove 114c. When the first arm 120a is then moved/rotated into its closed position (as shown in FIG. 1K), the additional cable is clamped between the clamping sections 122c and 112c of the clamping structures 120c and 116, respectively, as the clamping section 120c will move together with the first arm 120a. The device 103 may e.g. be beneficial if there is an additional cable that also needs to be clamped, and which is not for example suitable to be clamped together with the other cables, or similar. Reasons for this may include e.g. the additional cable having a dimension which is different from the other cables, the additional cable being a different type of cable, or similar, or any other reason for why it would be more suitable to clamp the additional cable as shown in FIGS. 1J and 1K. For example, one reason may be that the additional cable would require a different clamping force than the other cables, and which may not be provided using only the arms 120a and 120b as previously discussed herein while still providing a desired clamping force for the other cables. By configuring the exact shapes and positions of the clamping structures 120c and 116, as well as e.g. the exact shape of the clamping sections 122c and 112c as well as the groove 114c, the resulting clamping force for the additional cable may be tailored in accordance with what is required.

It is of course envisaged that there may be additional such clamping structures also provided, such as e.g. on/for the second arm 120b. The clamping sections of the clamping structures 120c and 116 as introduced in FIGS. 1J and 1K may of course also be configured to accommodate more than one additional cable.

There may also be provided more than one such additional clamping structure pair on/for each arm 120a and 120b.

Generally herein, although each drawing shows each arm 120a and 120b being able to receive two cables, a device as envisaged herein may of course also be capable of receiving e.g. only one cable at each clamping arm, or more than two cables at each clamping arm. The device may be configured such that the number of cables it may receive is configured according to a specific need. For example, to receive more cables, the length of the clamping sections of the arms and the base may be extended. In particular, as each arm may still be operable between its closed and open position individually of the other arm, multiple cables can be installed/clamped/removed without affecting multiple other cables already installed/clamped.

A device as envisaged herein can be manufactured from any suitable material, such as e.g. metal, composite, plastic, rubber, or similar. Manufacturing can be made using e.g. milling, machining, sintering, (die-)casting, extrusion, additive manufacturing (such as e.g. 3D-printing), or any combination of these or other suitable processes. The device need not necessarily be created from a same material, but individual parts of the device (such as the arms, base, foot, attachment points, screws, protrusions, hinges or other pivot-connection, or similar) can be made of their own, individual materials suited to their particular needs. As described herein, for example, the clamping sections may be made out of a metallic (or at least electrically conductive) material in order to provide an electrical connection to a stripped part of a cable, and it may be made certain that an electrically conductive path is provided between the clamping sections and the attachment points and/or underside of the foot of the base, in order to provide suitable earthing/grounding of the cables once the device is installed to a node. If such earthing/grounding is not necessary, the clamping sections may instead be made of other materials if desired, materials which do not need to be metallic. For example, as envisaged herein, combinations of materials such as metals, plastics and e.g. rubber may be well suited for creating the envisaged device. The exact combination of materials may however be selected depending on the environment (such as expected temperature, humidity, UV-irradiation, etc.) in which the device is to be installed, the required clamping forces, the materials of the cables which are to be clamped, the need for earthing/grounding, and similar.

In summary of the present disclosure, there is thus provided an improved clamping device which includes two clamping arms that are operable independent of each other. As a result of the independently operable arms, clamping and strain-relief of cables may be achieved in a more flexible way, wherein the installation/removal is made easier as cables can be added/clamped/removed to/by/from one arm without necessarily affecting one or more other cables already clamped in the device. Depending on a current need, the device may also be configured to provide earthing/grounding to one or more of the cables clamped therein.

Although features and elements may be described above in particular combinations, each feature or element may be used alone without the other features and elements or in various combinations with or without other features and elements. Additionally, variations to the disclosed embodiments may be understood and effected by the skilled person in practicing the claimed invention as defined by the appended patent claims, from a study of the drawings, the disclosure, and the appended claims themselves. In the claims, the words “comprising” and “including” does not exclude other elements, and the indefinite article “a” or “an” does not exclude a plurality. The mere fact that certain features are recited in mutually different dependent claims does not indicate that a combination of these features cannot be used to an advantage.

1.-15. (canceled)

16. A cable clamping device for a telecommunication network node, comprising:
a base including one or more attachment points for securing the base to the telecommunication network node; and
a first arm and second arm pivotably connected to the base around a respective pivot axis;
wherein the base and each of the first arm and the second arm are further configured such that one or more cables inserted between the arm and the base can be clamped between a clamping section of the arm and a corresponding clamping section of the base by pivoting the arm in a first direction to a closed position, and such that any such clamped one or more cables can be released by instead pivoting the arm in an opposite, second direction to an open position, and
wherein each of the first and second arms is operable between its respective open and closed positions independently of the other arm, such that any one or more cables clamped between the corresponding clamping sections of the arm and the base can be released without also releasing any one or more cables clamped between the corresponding clamping sections of the other arm and the base.

17. The device according to claim 16, wherein the pivot axes of the first and second arms are a same pivot axis.

18. The device according to claim 16, wherein for at least one of the first and second arms, at least one of the clamping section of the arm and the corresponding clamping section of the base has a metallic surface electrically connected to the one or more attachment points of the base.

19. The device according to claim 16, wherein for at least one of the first and second arms, at least one of the clamping section of the arm and the corresponding clamping section of the base has a metallic surface electrically connected to a metallic surface of the base arranged to, with the device mounted to the node, come into contact with the node.

20. The device according to claim 16, wherein for at least one of the first and second arms, the corresponding clamping section of the base includes one or more grooves for receiving the one or more cables and oriented along the pivot axis of the arm.

21. The device according to claim 20, wherein for said at least one of the first and second arms, the clamping section of the arm includes one or more protrusions for, with the arm in its closed position, pressing the one or more cables into the one or more grooves of the corresponding clamping section of the base.

22. The device according to claim 16, wherein the corresponding clamping sections of the base for the first and second arms are located on opposite sides of the base.

23. The device according to claim 22, wherein the base has a bottom section including the one or more attachment points, a top section where the first and second arms are pivotably connected to the base, and a middle section extending longitudinally between the bottom and top sections, and wherein the corresponding clamping sections of the base for the first and second arms are located on opposite lateral sides of the top section.

24. The device according to claim 23, wherein the corresponding clamping sections of the base for the first and second arms are angled with respect to a longitudinal extension of the base and/or middle section, and are closer together towards the respective pivot axes for the first and second arms than towards the middle section of the base.

25. The device according to claim 23, wherein a distance is provided between the bottom section and the top section including the corresponding clamping sections of the base for the first and second arms, to provide room therebetween in the middle section for one or more additional, not-to-be-clamped cables.

26. The device according to claim 16, wherein the first and second arms each includes a first end and a second end, wherein the clamping section of the arm is provided between the first and second ends of the arm, and wherein the arm is pivotably connected to the base at the first end.

27. The device according to claim 16, wherein the first and second arms each includes a screw held captive in the arm, and wherein the base further includes a corresponding threaded hole configured to receive said screw such that the arm is forced towards, or maintained in, its closed position by tightening the screw.

28. The device according to claim 26, wherein for each of the first and second arms, the screw is provided at the second end of the arm.

29. The device according to claim 27, wherein the corresponding threaded holes in the base for the first and second arms are aligned parallelly with a longitudinal extension of the base and/or middle section.

30. The device according to claim 16, wherein the base and each of the first and second arms are further configured such that at least two or more cables inserted between the arm and the base can be clamped between the clamping section of the arm and the corresponding clamping section of the base.
